(19) United States
(12) Patent Application Publication
(10) Pub. No.: US 2006/0190296 A1
(43) Pub. Date: Aug. 24, 2006

(54) Method and system for referring healthcare professionals in compliance with various transaction constraints

(75) Inventors: Donald Hackett, Washington, DC (US); Louis Scapatti, Austin, TX (US)

Correspondence Address: HULSEY IP INTELLECTUAL PROPERTY LAWYERS, P.C., 1250 S. CAPITAL OF TEXAS HIGHWAY, BUILDING THREE, SUITE 160, AUSTIN, TX, 78746, US

(73) Assignee: MyDNA.com, Inc.

(21) Appl. No.: 11/185,211

(22) Filed: Jul. 20, 2005

Related U.S. Application Data
(60) Provisional application No. 60/589,448, filed on Jul. 20, 2004.

(51) Int. Cl. G06Q 10/00

(52) U.S. Cl. 705/2; 707/3

(57) ABSTRACT

Techniques for providing public access to a predetermined class of healthcare providers using a plurality of electronic communications systems and in compliance with a predetermined set of regulatory criteria governing the provision of healthcare. The method and system establish an electronic healthcare provider database of regulatory requirements associated with public access to healthcare providers and then establish an electronic database of healthcare providers. The electronic database of healthcare may be populated by the predetermined class of healthcare providers. The electronic system provides to the healthcare providers an entry access interface a plurality of electronic communications systems to the electronic database of healthcare providers. The entry access interface corresponds to the predetermined set of regulatory criteria. Public entry access is provided to the electronic healthcare provider database through a plurality of electronic communications systems for a consumer to access selected healthcare providers while assuring electronically that the consumer access to the predetermined class of healthcare provides satisfies the predetermined set of regulatory criteria governing the provision of healthcare.

### CROSS REFERENCE TO RELATED APPLICATION

This patent application claims the benefit of U.S. Provisional Patent Application No. 60/589,448, entitled, “METHOD AND SYSTEM FOR REFERRING HEALTHCARE PROFESSIONS IN COMPLIANCE WITH VARIOUS TRANSACTION CONSTRAINTS,” and filed July 2004.

### TECHNICAL FIELD OF THE INVENTION

This invention relates generally to a system and method for online selection of healthcare services and, more particularly, to a system and method for allowing a user to select a physician or other healthcare resource and for providing the user with healthcare services in compliance with referral and similar transaction constraints.

### BACKGROUND OF THE INVENTION

The Federal Anti-kickback Statute, 42 U.S.C. § 1320a-7b(b), prohibits any person or entity from making or accepting payment to induce or reward any person for referring, recommending or arranging for Federally-funded medical services, including services provided under the Medicare, Medicaid and TRICARE programs. It arose out of congressional concern that payoffs to those who can influence healthcare decisions will result in goods and services being provided that are medically unnecessary, of poor quality, or even harmful to a vulnerable patient population.

To protect the integrity of the program from these difficult-to-detect harms, Congress enacted a per se prohibition against the payment of kickbacks in any form, regardless of whether the particular kickback gave rise to over-utilization or poor quality of care.

Federal Anti-Kickback statute, 42 U.S.C. 1320a-7b states that “Whoever knowingly and willfully solicits or receives any remuneration (including any kickback, bribe, or rebate) directly or indirectly, overtly or covertly, in cash or in kind (a) in return for referring an individual to a person for the furnishing or arranging for the furnishing of any item or service for which payment may be made in whole or in part under a Federal healthcare program, or (b) in return for purchasing, leasing, ordering, or arranging for or recommending purchasing, leasing, or ordering any good, facility, service, or item for which payment may be made in whole or in part under a Federal healthcare program, shall be guilty of a felony and upon conviction thereof, shall be fined not more than $25,000 or imprisoned for not more than five years, or both.

Although this statute does not expressly define “referral” the breadth of the term is evidenced in the following definition as it relates to referrals for physician services: Except as provided in subparagraph (c), in the case of an item or service for which payment may be made under part B of this subchapter, the request by a physician for the item or service, including the request by a physician for a consultation with another physician (and any test or procedure ordered by, or to be performed by (or under the supervision of) that other physician), constitutes a “referral” by a “referring physician”. (b) Other items include that except as provided in subparagraph (c), the request or establishment of a plan of care by a physician which includes the provision of the designated health service constitutes a “referral” by a “referring physician.” (c) Clarification respecting certain services integral to a consultation by certain specialists.

A request by a pathologist for clinical diagnostic laboratory tests and pathological examination services, a request by a radiologist for diagnostic radiology services, and a request by a radiation oncologist for radiation therapy, if such services are furnished by (or under the supervision of) such pathologist, radiologist, or radiation oncologist pursuant to a consultation requested by another physician does not constitute a “referral” by a “referring physician.” (42 U.S.C. 1395nn(h) (5))

The pharmaceutical industry in recent years has spent more than $10 billion annually on “marketing.” Some would argue that a relatively significant portion of this may have been used to provide unlawful inducements in exchange for prescriptions. True or not, now is the time for healthcare leaders to understand that every healthcare organization that violates the Federal Anti-kickback Statute by accepting benefits from a pharmaceutical company is risking civil and criminal liability, and that the only way to protect themselves in the future is to build a firewall between themselves and the pharmaceutical industry.

Healthcare leaders must take steps to ensure that their company's relationships with pharmaceutical companies withstand the strict scrutiny that is emerging. Healthcare organizations, not just physicians, must re-examine how they are interacting with pharmaceutical companies, and take steps to avoid the receipt of anything of value. Compliance oversight must be directed not just to physicians, but also to pharmacy directors, purchasing agents, department directors, materials management professionals, and anyone else who is in a position to receive cash, services, or items of value from pharmaceutical companies.

Since 1990, when the American Medical Association's Council on Ethical and Judicial Affairs first created guidelines on gifts to physicians from the pharmaceutical industry, they have largely been ignored. What's worse, they were filled with loopholes and gray areas, opening the door to the next wave of fraud and abuse. For example, they allowed for gifts to doctors from pharmaceutical companies, but stipulated that they should be of benefit to patients and of minimal value. They permitted industry subsidies for conferences and meetings, but prohibited them from being given directly to doctors. Camels could get in through the eye of these needles—and they did.

Reality check: Since 1999, there has been a groundswell of government investigations, civil lawsuits and criminal prosecutions, all concerning the sales, marketing and pricing practices of pharmaceutical companies. Indeed, major drug companies, including Bristol-Myers Squibb, Biovail Corp., and Schering-Plough Corp., just to name a few, face government probes of sales and marketing practices. TAP Pharmaceutical Products Inc., Pfizer Inc., AstraZeneca Pharmaceutical, L. P., Bayer Corp. and GlaxoSmithKline, for example, have relatively recently resolved cases in which their marketing and/or pricing practices were at issue.

Even legislators have joined the hunt. In June, the House Energy and Commerce Committee sent letters to over two dozen pharmaceutical companies as part of its investigation into pharmaceutical reimbursements and rebates under the Medicaid program.

Risk areas for healthcare organizations and pharmaceutical companies include (a) price concessions and similar benefits (kickbacks) made to induce the purchase of prescription drug products, which in turn would violate the Federal Anti-kickback Statute; (b) switching arrangements, where pharmacies, PBMs, or other controllers of the market are offered cash payments or other benefits each time a patient's prescription is changed to the manufacturer's product from a competing product; (c) consulting and advisory payments, created to disguise kickbacks, and not made on the basis of a legitimate arrangement with a physician to perform research, data collection, etc.; and (d) other remuneration, including entertainment, recreation, travel, meals, sponsorship or other financing relating to third party educational conferences, including grants and scholarships, gifts and gratuities.

The practice of providing drug samples (usually injectable or cancer drugs which are directly billable by healthcare providers) provided to physicians who, in turn, bill them to the Federal healthcare programs.

The purposeful manipulation of the AWP (a benchmark for Medicare and Medicaid reimbursement) to increase physician or institutional profits—known as “marketing the spread”—a practice that could alter a physician's judgment.

In April, 2003, the Department of Health and Human Services, Office of Inspector General (“OIG”) released its final “Compliance Program Guidance For Pharmaceutical Manufacturers.” “This Guidance explains the value of compliance programs and details specific elements that pharmaceutical manufacturers should consider when developing and implementing an effective compliance program,” Former Inspector General Janet Rehnquist said at the time of its release. “It is designed to help companies prevent healthcare fraud and abuse by promoting a high level of ethical and lawful corporate conduct.”

Like it or not, healthcare organizations now have no choice but to adopt a policy of zero tolerance regarding accepting pharmaceutical marketing inducements. Those who claim that pharmaceutical companies have a right to advertise and educate healthcare professionals about their products are purposely trying to muddy the issue. Legitimate education and advertising is in no way, shape, or form to be confused with giving remuneration or items of value as inducements to prescribe their drugs—and deep down, everyone knows the difference between the two.

The best way for healthcare organizations to protect themselves is to accept nothing, not even the slightest trinket, from a pharmaceutical company. Without a firewall between themselves and pharmaceutical companies, healthcare organizations are opening the door for the next round of qui tam whistleblowers and government enforcement to be directed at them—not just at the pharmaceutical companies. Times have changed. Pharmaceutical companies have begun the process—healthcare organizations must change with them—or hold themselves responsible for the negative consequences of their own making.

Referrals, however, are an inherent component of relationships between hospitals and physicians, the prohibition of which conflicts with the complexity of healthcare delivery. Hospitals can meet the healthcare needs of the communities they serve only with the assistance and coordination of physicians. Hospital care must be provided by and through arrangements with physicians. Physicians rely upon the assistance and support of the hospital's clinical staff and facilities to diagnose and treat patients.

The definition of the term “referral” includes most of the daily interactions that physicians have with hospitals. When a physician admits a patient with chest pain, it is a “referral.” When a physician uses a hospital surgical suite to perform surgery in conjunction with a team of hospital nurses, it is a “referral.” When a physician orders a blood test performed by the hospital's laboratory, it is also a “referral.” And when a physician discharges a patient and orders post-hospital services in conjunction with hospital discharge planners, it is a “referral.” Since physicians are licensed to make medical judgments and order services, a “referral” is a necessary yet intrinsic component of virtually every interaction between a hospital and a physician.

Several examples of common, beneficial hospital-physician relationships that are threatened by a mistakenly broad construction of the Anti-kickback Statute. These examples have two common, coexisting features: (1) an economic relationship is formed that is necessary for patient care; and (2) patients receive needed services from the referrals the physicians have made. These examples, therefore, all involve “remuneration” and “referrals” as a natural part of the relationship, but without the required nexus of criminal inducement.

Clinical and administrative services provide a first example of a referral process. Hospitals have important medical reasons to contract with physicians to provide clinical services to patients. Similarly, hospitals often ask physicians to provide medical administrative services, such as serving as the medical director of a program or department. The hospital customarily pays the physician for these duties.

A hospital, for example, may have a choice of hiring one of the leading surgeons in the field as a medical director or an accomplished, but lesser known, physician. The leading surgeon will likely bring to the institution prestigious research grants and superior education and training. This surgeon also will likely attract more referrals because of her name recognition. Moreover, when that surgeon agrees to become the medical director of that service, it should surprise no one that she will actually refer her patients to her service at the hospital. When she starts her work at that hospital, she will expect to be paid. In this example, the selection of the leading surgeon could be construed as a criminal offense under a broad reading of the Anti-Kickback Statute, unless the surgeon is selected for “legal reasons” that are “entirely distinct” from the prospect of referrals to the hospital. To avoid the danger of criminal prosecution, the hospital might not select the leading surgeon or that surgeon might tell her patients to go elsewhere. Physician Recruitment provides yet another example a referral process. Hospitals often consider ways to recruit physicians to locate to the hospital's service area after the completion of residency training. This recruitment usually follows the completion of a community “needs analysis” by which the hospital has identified needs for various categories of physician-specialists in the service area, which may include necessary hospital services based on community demographics. As part of its efforts to recruit a physician, the hospital typically provides the physician with a moving allowance and an income guarantee to ease the financial burden while the physician establishes a private practice. In addition, the physician is asked to obtain and maintain medical staff privileges at the supporting hospital. Since the physician will likely admit patients to the hospital, both elements of the offense are present.

Flight programs are still a further referral process example. As part of their community service, hospitals in urban areas often sponsor flight programs to provide needed specialty care to surrounding rural areas. Physicians on the hospital's medical staff are flown to rural areas to see patients at rural hospitals or clinics. These flights are provided without charge, and therefore the physicians may be considered to have received remuneration. Even though the physicians earn fees for the care they provide, the amounts received rarely would justify the flights if they paid the full cost themselves. The primary purpose of the flight programs is to provide needed treatment to patients in a setting close to their home. If more needed services are not available locally, the physician will usually refer the patient to the sponsoring hospital at which she is on the medical staff.

None of the above practices has traditionally been viewed as unethical or as increasing the costs of medical programs or treatments. Absent other aggravating facts, these arrangements to provide needed services and many other everyday practices of hospitals and physicians should not be subjected to criminal investigation and prosecution.

Not all arrangements that have “referrals” as an inherent component are illegal. On the other hand, practices which have long been regarded by professional organizations as unethical as well as unlawful in some jurisdictions, and which contribute appreciably to the cost of the Medicare and Medicaid programs are the target of the Anti-Kickback Statute. Consequently, financial arrangements between referral sources constitute a crime only where the parties paid or received remuneration to induce referrals with criminal intent, i.e. to do something with knowledge their conduct is illegal. Financial relationships between hospitals and physicians only “where the motivation to enter into the relationship is for legal reasons entirely distinct from the collateral hope for or decision to make referrals.”

Other regulations relate to healthcare and medical services advertising. According to the FTC, an advertisement is deceptive under the Federal Trade Commission Act if it contains a material representation or omission of fact that is likely to mislead consumers acting reasonably under the circumstances. Advertisers are also responsible for claims that are reasonably implied from their statements. These rules apply to all advertisements, including consumer testimonials. In addition, advertisers must be able to substantiate all objective claims they make about a product or service.

In general, the FTC is responsible for protecting consumers against false or misleading advertising and other deceptive trade practices. The FDA regulates drugs and medical devices, including the advertising or labeling of devices such as the excimer laser. The agency has approved certain lasers as safe and effective for LASIK, PRK, and other specific uses. Thus far, the Summit, VISX, and Technolas 217 lasers have been approved for LASIK. For any other laser, LASIK is still considered an “off-label” use of the laser.

Voluntary compliance in healthcare advertisements has risen due to numerous investigations, as well as increasing government and whistleblower scrutiny concerning sales and marketing practices. The pharmaceutical industry, for example, has banded together through the Pharmaceutical Research and Manufacturers of America (“PhRMA”) to adopt a voluntary code on interactions with physicians. Adopted on Apr. 18, 2002, the new code went into effect for PhRMA's members on Jul. 1, 2002. While the effectiveness of a voluntary code may be questionable to some, it marked a first step in the recognition that compliance with the Federal Anti-kickback Statute had increasing importance.

The American Medical Association also has instituted policies governing advertising and publicity. For example, Section E-5.02 of these guidelines states that there are no restrictions on advertising by physicians except those that can be specifically justified to protect the public from deceptive practices. A physician may publicize him or herself as a physician through any commercial publicity or other form of public communication (including any newspaper, magazine, telephone directory, radio, television, direct mail, or other advertising) provided that the communication shall not be misleading because of the omission of necessary material information, shall not contain any false or misleading statement, or shall not otherwise operate to deceive.

As can be seen, a significant body of Federal legislation and regulation permeates the field of professional health and medical care advertising and market access. These restrictions and regulations must also be adhered to in on-line or eCommerce situations. In fact, it can be said that such regulation may have had a material effect on a lack of Internet or eCommerce use by physicians and medical healthcare providers. For example, approximately 3 out of 10 (29%) physicians using the Web currently have a Web site. After increasing significantly from 1997 (17%) to 1999 (27%), the proportion of physicians that have a site on the Web has remained constant for the past few years. Web sites are greatest among physicians in solo or two physician practice (40%) and lowest among physicians in a hospital-based practice (15%) or other type of practice (23%). The primary reasons physicians have a site on the Web include (a) 43% to promote and advertise their practice; (b) 35% to provide patient education and information; (c) 11% increase in physicians using the Web to advertise and promote their practice since 2000.

In light of these motivations, there is a need for an on-line method and system that avoids the draconian consequences of criminal penalties associated with failing to comply with Federal Anti-Kickback and other statutes, as well as voluntary professional guidelines and regulations relating to the general public's access to physicians, pharmaceuticals and other medical healthcare providers, services, and products.

### SUMMARY

Techniques for providing online selection of healthcare services and, more particularly, to a system and method for allowing a user to select a physician or other healthcare resource and for providing the user with healthcare services in compliance with referral and similar transaction constraints.

The method and system establish an electronic healthcare provider database of regulatory requirements associated with public access to healthcare providers and then establish an electronic database of healthcare providers. The electronic database of healthcare may be populated by the predetermined class of healthcare providers. The electronic system provides to the healthcare providers an entry access interface a plurality of electronic communications systems to the electronic database of healthcare providers. The entry access interface corresponds to the predetermined set of regulatory criteria. Public entry access is provided to the electronic healthcare provider database through a plurality of electronic communications systems for a consumer to access selected healthcare providers while assuring electronically that the consumer access to the predetermined class of healthcare provides satisfies the predetermined set of regulatory criteria governing the provision of healthcare.

The method and system establish an electronic healthcare provider database of regulatory requirements associated with public access to healthcare providers and then establish an electronic database of healthcare providers. The electronic database of healthcare may be populated by the predetermined class of healthcare providers. The electronic system provides to the healthcare providers an entry access interface a plurality of electronic communications systems to the electronic database of healthcare providers. The entry access interface corresponds to the predetermined set of regulatory criteria. Public entry access is provided to the electronic healthcare provider database through a plurality of electronic communications systems for a consumer to access selected healthcare providers while assuring electronically that the consumer access to the predetermined class of healthcare provides satisfies the predetermined set of regulatory criteria governing the provision of healthcare.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages be included within this description, be within the scope of the accompanying claims.

### BRIEF DESCRIPTIONS OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 provides a conceptual illustration of one embodiment of the invention;

FIG. 2 illustrates one possible interface that may employ the teachings of the present invention;

FIG. 3 depicts a flow diagram of functions between the consumer side and provider side of the disclosed subject matter leading to healthcare provider database connection;

FIG. 4 presents safe harbour flow diagram relating to FIG. 3 wherein a provider seeks additional appointments; and

FIG. 5 shows consumer a Safe Harbour diagram corresponding to FIG. 3 and the actions relating to a consumer searching for a provider via the web, phone, device, email, or other means.

### DESCRIPTION OF THE PRESENT EMBODIMENT

The present invention provides a method and system for providing public access to physicians, prescription pharmaceuticals, and other healthcare services and products including certain business practices between an on-line or Internet physician resource and physician referral services associated with hospitals or hospital systems in various locations. The present invention provides such a method and system without violating certain prohibitions in Federal statutes prohibiting certain payment practices involving referrals of patients or purchases or other acquisitions of certain items, such as those reimbursable under Medicare, Medicaid, and other Federal programs and restrictions.

In one embodiment, a health services referral service is provided through which potential patients may access various types of health services. When a potential patient access the system of the present invention, the patient receives a list of health services available through a user interface with physician services being one choice. If a patient chooses physician services, the interface then prompts the patient to select a more specific type of provider services, followed by a further set of refining choices about the specific type of provider service or specialist the user seeks.

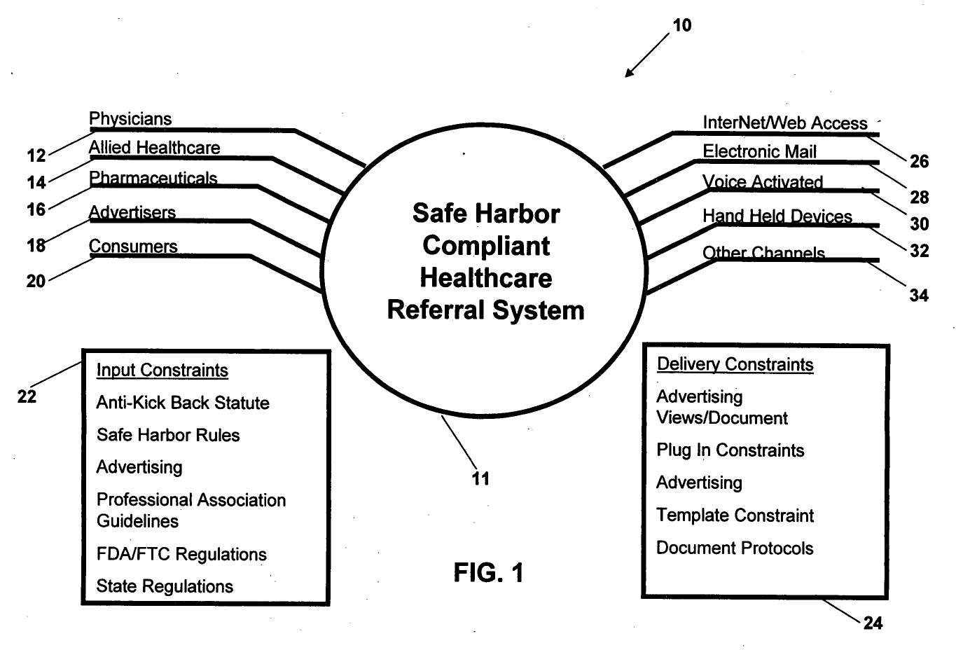

FIG. 1 provides a conceptual illustration of one embodiment of the invention, wherein health services referral system 10 includes safe Harbour compliant healthcare referral system hub or platform 11. Platform 11 provides a communications pathway through which providers, including physicians 12, allied healthcare providers 14, pharmaceutical resources 16, advertisers 18, and consumers 20 may communicate their services and business transactions in accordance with the various legal and business input constraints 22. Such input constraints may include, for example, the Anti-Kick Back Statute herein described, its Safe Harbour Rules, FTC advertising constraints, professional association guidelines (such as those of the AMA and other medical associations), FDA/FTC Regulations, as well as various state Regulations

Platform 11, in response and in compliance with many technical and business constraints 24 provides through a coordinated variety of channels, a set of Safe Harbour Rule compliant healthcare referrals to users. The delivery constraints may include the number of advertising views per document, website plug-in feature constraints, advertising/pop-up add constraints, template constraint, document protocols, and the like. Such users may interface platform 11 using an Internet/Web Access 26, an electronic mail messaging access 28, a voice activated or 800 service channel 30, a hand held device channel 32, or other channels 34.

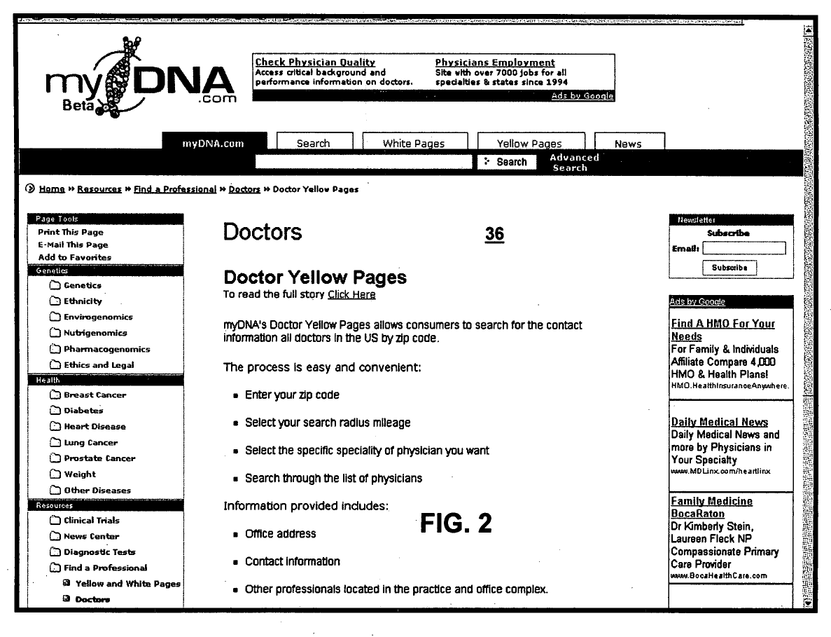

FIG. 2 illustrates one possible interface 36 that may employ the teachings of the present invention. In particular Doctors interface 36 may include Doctor Yellow Pages for allowing a user to search for the contact information all doctors in the US by zip code. Using a search engine whose formation fully complies with the Safe Harbour Rules in all respects, the present embodiment allows a user to enter his zip code, select a search radius mileage, sought specialty of a desired physician, and search through the list of physicians all of whom have been associated with the platform in compliance with the Safe Harbour or similar transactions. The provided information includes the doctors' office address, contact information, and other professionals located in the practice and office complex.

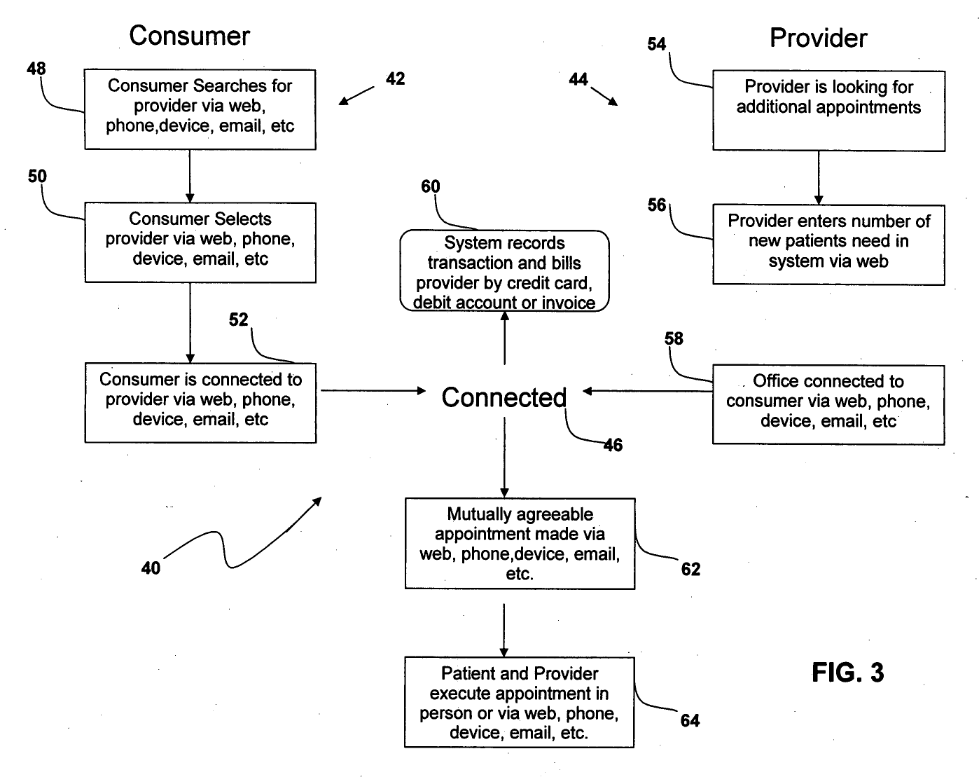

FIG. 3 depicts a flow diagram 40 between the consumer side 42 and provider side 44 leading to connection 46. From consumer side 42, a consumer may search for a health care provider at step 48 via an Internet or web connection, a phone connection, a PDA or device connection, or an email connection. The consumer then, at step 50, may select a provider via the Web, the phone, a device, or email. Thereafter, at step 52, the consumer is connected with the provider. On provider side 46, a provider may be looking for additional appointments at step 54. The provider may enter the number of new patients desired in the system via the Internet at step 56. At step 58, a connection between the provider and the consumer may occur to achieve connection 46. From connection 46, the system records at step 60 the transaction and bills the provider by credit card, debit account or invoice. Also, once connection 46 occurs, a mutually agreeable appointment may be made via the web, phone, device, email, or other means, at step 62. At step 64, the consumer becomes a patient and the provider executes an appointment in person or via the web, phone, device, email, etc.

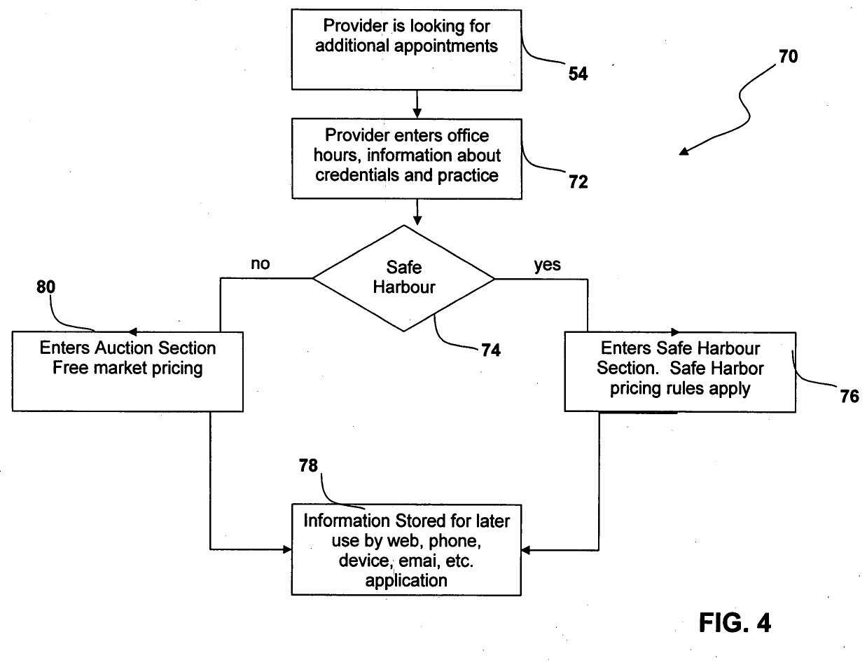

FIG. 4 presents safe Harbour flow diagram 70 relating to step 54 of FIG. 3 wherein a provider is looking for additional appointments. In step 72, a provider enters office hours, information about credentials and practice. Then, at query 74 the Safe Harbour requirements herein described are tested. If the Safe Harbour requirements are met, then process flow continues to step 76, at which point the process enters the Safe Harbour section and Safe Harbour pricing rules apply. Then, process flow continues to step 78 for information to be stored for later use by applications residing on the web, on a phone service, an electronic device, or email, for example. If, on the other hand, Safe Harbour rules do not apply, then process flow continues to step 80, at which point the process enters an auction section for free market pricing.

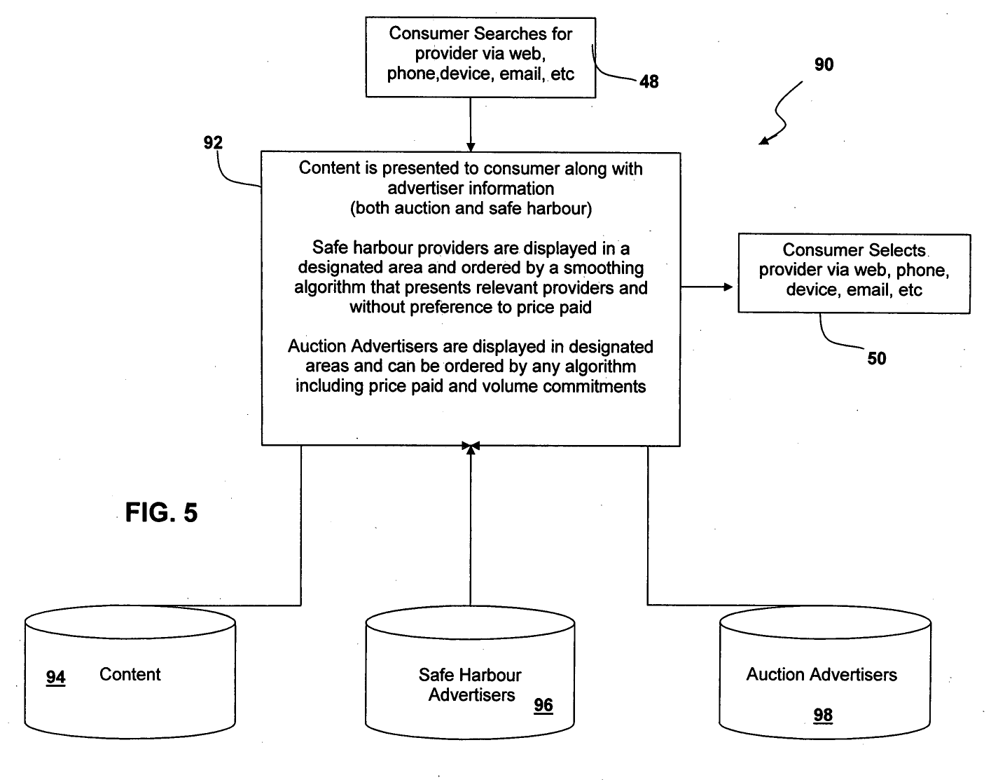

FIG. 5 shows consumer Safe Harbour diagram 90 corresponds to step 48 of FIG. 3 and the actions relating to a consumer searching for a provider via the web, phone, device, email, or other means. From step 48, the process will continue to step 92 at which point the disclosed subject matter provides to the consumer content and advertiser information. This occurs for both auction and Safe Harbour branches of the present process. For Safe Harbour providers, the process displays such providers in a designated area and orders them by a smoothing algorithm that present relevant providers and without preference to price paid. On the other hand, the process displays auction advertisers in designated areas so as to order them by any algorithm including price paid and volume commitments. Inputs into operations occurring at step 92 include content from content database 92, Safe Harbour Advertisers data from Safe Harbour database 96, and Auction Advertisers data from Auction Advertisers database 98. Output from step 92 enables the consumer, at step 50, to select a provider via the web, phone, device, email, etc.

Upon using a set of interface menus, based on the user's ZIP code, in one embodiment, the user may be directed by the present system to a referral service in the patient's contacting area. The referral service may then cooperate with the user to more completely understand the user's medical needs. Once the referral service has determined a provider referral is warranted, the user may be directed to an appropriate physician. Before connecting the user to the referral service, the present method and system notify the user that the user is being transferred to a “sponsoring provider.”

The relationship between method and system of the present invention and each of the referral services is relatively simple. There is a one-year renewable written contract between the two parties which specifies the services to be provided through the present invention (consisting of delivering individual patients in the relevant geographic area to a telephone destination designated by the referral service) and the pricing for the service. The contracts are non-exclusive, available to all provider referral services. If there is more than one referral center in a given geographic area, access to the users made is possible by being distributed to all contracting referral services. No compensation other than a charge for the services being made available to users is paid by the referral service and the present invention does not participate or associate with the ultimate referral of the user to an appropriate physician.

The present method and system, therefore, comply with the restrictions applicable to the Medicare and Medicaid Act (the “Anti-Kickback Rules”), which prohibit the offer, solicitation, payment or receipt of remuneration in any form directly or indirectly to induce or in return for (1) referral of a person for items or services reimbursable under Medicare or Medicaid or (2) purchasing, leasing, ordering, or arranging for recommending purchasing, leasing, or ordering any good, facility, service or item reimbursable under Medicare or Medicaid. 42 USC §§1320a-7b(b) (1), (2)). The present invention, therefore avoids for the referral service the severe criminal and civil penalties can be imposed for violations of the Anti-Kickback Rules, while providing an on-line or eCommerce access to the referral service.

The present method and system, therefore, provides in an on-line, Internet based platform a robust mechanism which complies with the exceptions to the prohibitions of the Anti-Kickback Rules which allow parties to engage in practices qualifying for those exceptions that otherwise would violate the Rules. By complying with the “Safe Harbour Rules” of 42 CFR §1001.952(d)) the present method and system, not only provide a significantly improved process for permitting access to physicians and the healthcare community, but also provide such access in a legally permissible way.

With respect to the relationship between the method and system of the present invention and the various referral services with which it associates, the referral transactions in which the present method and system engages are outside the scope of the Anti-Kickback Rules. While a referral service may pay “remuneration” to a provider of the present method and system for a forwarded user contact, and while there may be a “referral” by the present method and system to a referral service, such a “referral” does not result in the furnishing or arranging for the furnishing of any item or service reimbursable under Medicare, Medicaid or similar Federal program. Nor does the “referral” result in the purchase, lease, order, or arrangement for recommending the purchase, lease, or order of any good, facility, service or item that is reimbursable under Medicare, Medicaid or similar Federal program.

The referral service is neither a provider nor a supplier under any such program and accordingly no reimbursable transaction arises from the interaction of the present method and system and a referral service. Instead, a referral service may make a further referral to a provider or supplier for reimbursable services or items but the present method and system is not part of such a transaction. Accordingly, the basic relationship between the present method and system and a referral service appears not to fall within the basic prohibitions of the Anti-Kickback Rules. However, even if the Anti-Kickback Rules were implicated in the contractual relationship between the two parties, a resulting contract qualifies under the Safe Harbour Rules.

The method and system of the present invention comply with the referral service Safe Harbour Rules which are effective when “remuneration” does not include any payment or exchange of anything of value between an individual or entity (“participant”) and another entity serving as a referral service (referral service”). The Safe Harbour Rules are effective, because in the method and system of the present invention the following four standards are met—(a) the referral service does not exclude as a participant in the referral service any individual or entity who meets the qualifications of participation; (b) any payment the participant makes to the referral service is assessed equally against and collected equally from all participants, and is only based on the cost of operating the referral service, and not on the volume or value of any referrals to or business otherwise generated by the participants for the referral service for which payment may be made in whole or in part under Medicare or a State healthcare program; (c) the referral service imposes no requirements on the manner in which the participant provides services to a referred person, except that the referral service may require that the participant charge the person referred at the same rate as it charges other persons not referred by the referral service, or that these services be furnished free of charge or at reduced charge; and (d) the referral service makes five disclosures to each person seeking a referral. Each of the five disclosures are maintained by the referral service in a written record certifying such disclosure and signed by either such person seeking a referral or by the individual making the disclosure on behalf of the referral service.

The five disclosures are the following: (i) the manner in which it selects the group of participants in the referral service to which it could make a referral, (ii) whether the participant has paid a fee to the referral service; (iii) the manner in which it selects a particular participant from this group for that person; (iv) the nature of the relationship between the referral service and the group of participants to whom it could make the referral; and (v) the nature of any restrictions that would exclude such an individual or entity from continuing as a participant.”

The method and system of the present invention meet the first three prongs of the Safe Harbour Rules. In particular, physicians will pay nothing to participate and continuing participation will not be conditioned on referral patterns. The method and system of the present invention makes these disclosures and, thereby, meet the final prong of the four part test. With these requirements met, the method and system of the present invention would not violate the Anti-Kickback statute.

With the present method and system, physician participation is cost-free to the physician because of the present invention's reliance on pharmaceutical manufacturers to pay substantial fees in order to claim exclusive sponsorship of certain diseases or conditions. In essence, the pharmaceutical companies pay for advertising through user interface of the present invention—just as the participating physicians are receiving free advertising as a result of the payment of sponsorship fees by the pharmaceutical companies.

The indirect remuneration to the physicians presented by these fees poses a risk that is not unreasonable so long as the pharmaceutical companies have (1) no direct or indirect influence over which physicians participate in the referral program, (2) no direct or indirect influence over which physicians are actually chosen by the users of the referral service, (3) no direct contact/communication whatsoever with the participating physicians through the method and system of the present invention, and (4) no financial relationship with the participating physicians through the method and system of the present invention.

The method and system of the present invention, therefore, benefits from the fact that present invention does not engage in the delivery of healthcare and, further, because its advertising is passive in nature, not involving direct contact with program beneficiaries. Maintaining this buffer between the physicians and the pharmaceutical companies is critical to maintaining a reasonable level of anti-kickback exposure.

In addition to the Anti-Kickback legal issues that we are addressing, we have identified other legal issues to take under consideration including (1) how sponsorship disclosures will be made on the method and system of the present invention websites to ensure that state and Federal consumer protection laws are properly adhered to, (2) whether the method and system of the present invention (references to HIPAA Compliant products and the facilitation of electronic communications directly between schedule and patients) accurately articulates patient privacy and security requirements including those identified in the Health Insurance Portability and Accountability Act (HIPAA), (3) whether the healthcare counselors are adequately trained to avoid inadvertently inviting medical practice liability.

The processing features and functions described herein can be implemented in various manners. The present embodiments may be implemented in an application specific integrated circuit (ASIC), a microcontroller, a microprocessor, or other electronic circuits designed to perform the functions described herein. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for providing public access to a predetermined class of healthcare providers using a plurality of electronic communications systems and in compliance with a predetermined set of regulatory criteria governing the provision of healthcare, comprising the steps of:
establishing an electronic healthcare provider database of regulatory requirements associated with public access to a predetermined class of healthcare providers;
establishing an electronic database of healthcare providers, said electronic database of healthcare providers being capable of population by said predetermined class of healthcare providers;
providing to said predetermined class of healthcare providers an entry access interface through at least one of a plurality of electronic communications systems to said electronic database of healthcare providers, said entry access interface corresponding to said predetermined set of regulatory criteria;
providing public entry access to said electronic healthcare provider database through at least one of a plurality of electronic communications systems for a consumer to access selected ones of said predetermined class of healthcare providers; and
assuring electronically that said consumer access to said predetermined class of healthcare provides satisfies said predetermined set of regulatory criteria governing the provision of healthcare.

2. The method of claim 1, further comprising the step of assuring electronically that said consumer access to said predetermined class of healthcare provides satisfies Safe Harbour regulatory criteria governing the provision of healthcare.

3. The method of claim 1, further comprising the step of assuring electronically that said consumer access to said predetermined class of healthcare provides satisfies Auction regulatory criteria governing the provision of healthcare.

4. The method of claim 1, further comprising the step of providing said predetermined class of healthcare providers entry access for advertising information to said electronic database of healthcare providers.

5. The method of claim 1, further comprising the step of providing to said predetermined class of healthcare providers an Internet-based entry access interface to said electronic database of healthcare providers, said Internet-based entry access interface corresponding to said predetermined set of regulatory criteria.

6. The method of claim 1, further comprising the steps of providing to said predetermined class of healthcare providers a wireless handset-based entry access interface to said electronic database of healthcare providers, said wireless handset-based entry access interface corresponding to said predetermined set of regulatory criteria.

7. The method of claim 1, further comprising the step of providing public entry access to said electronic healthcare provider database through an Internet-based interface for a consumer to access selected ones of said predetermined class of healthcare providers.

8. The method of claim 1, further comprising the steps of providing public entry access to said electronic healthcare provider database through a wireless handset-based interface for a consumer to access selected ones of said predetermined class of healthcare providers.

9. The method of claim 1, further comprising the step of permitting said consumer to set a mutually agreeable appointment via at least one of said electronic communications system with a selected one of said predetermined class of healthcare providers.

10. A system for operation in association with a healthcare provider system for providing public access to a predetermined class of healthcare providers using a plurality of electronic communications systems and in compliance with a predetermined set of regulatory criteria governing the provision of healthcare, comprising:
an electronic healthcare provider database of regulatory requirements associated with public access to a predetermined class of healthcare providers;
an electronic database of healthcare providers, said electronic database of healthcare providers being capable of population by said predetermined class of healthcare providers;
at least one of a plurality of electronic communications systems for providing to said predetermined class of healthcare providers an entry access interface to said electronic database of healthcare providers, said entry access interface corresponding to said predetermined set of regulatory criteria;
at least one of a plurality of electronic communications systems for providing public entry access to said electronic healthcare provider database for a consumer to access selected ones of said predetermined class of healthcare providers; and
a regulatory criteria compliance mechanism for assuring electronically that said consumer access to said predetermined class of healthcare provides satisfies said predetermined set of regulatory criteria governing the provision of healthcare.

11. The system of claim 10, further comprising instructions for assuring electronically that said consumer access to said predetermined class of healthcare provides satisfies Safe Harbour regulatory criteria governing the provision of healthcare.

12. The system of claim 10, further comprising instructions for assuring electronically that said consumer access to said predetermined class of healthcare provides satisfies Auction regulatory criteria governing the provision of healthcare.

13. The system of claim 10, further comprising instructions for providing said predetermined class of healthcare providers to provide advertising information to said electronic database of healthcare providers.

14. The system of claim 10, further comprising instructions for providing to said predetermined class of healthcare providers an Internet-based entry access interface to said electronic database of healthcare providers, said entry access interface corresponding to said predetermined set of regulatory criteria;

15. The system of claim 10, further comprising instructions for providing to said predetermined class of healthcare providers a wireless handset-based entry access interface to said electronic database of healthcare providers, said entry access interface corresponding to said predetermined set of regulatory criteria.

16. The system of claim 10, further comprising instructions for providing public entry access to said electronic healthcare provider database through an Internet-based interface for a consumer to access selected ones of said predetermined class of healthcare providers.

17. The system of claim 10, further comprising instructions for providing public entry access to said electronic healthcare provider database through a wireless handset-based interface for a consumer to access selected ones of said predetermined class of healthcare providers.

18. The system of claim 10, further comprising instructions for permitting said consumer to set a mutually agreeable appointment via at least on of said electronic communications system with a selected one of said predetermined class of healthcare providers.

19. A computer usable medium having computer readable program code means embodied therein for providing public access to a predetermined class of healthcare providers using a plurality of electronic communications systems and in compliance with a predetermined set of regulatory criteria governing the provision of healthcare, the computer usable medium comprising:
computer readable program code means for establishing an electronic healthcare provider database of regulatory requirements associated with public access to a predetermined class of healthcare providers;
computer readable program code means for establishing an electronic database of healthcare providers, said electronic database of healthcare providers being capable of population by said predetermined class of healthcare providers;
computer readable program code means for providing to said predetermined class of healthcare providers an entry access interface through at least one of a plurality of electronic communications systems to said electronic database of healthcare providers, said entry access interface corresponding to said predetermined set of regulatory criteria;
computer readable program code means for providing public entry access to said electronic healthcare provider database through at least one of a plurality of electronic communications systems for a consumer to access selected ones of said predetermined class of healthcare providers; and
computer readable program code means for assuring electronically that said consumer access to said predetermined class of healthcare provides satisfies said predetermined set of regulatory criteria governing the provision of healthcare.

20. The computer usable medium of claim 19, further comprising computer readable program code means for permitting said consumer to set a mutually agreeable appointment via at least on of said electronic communications system with a selected one of said predetermined class of healthcare providers
